(19) United States
(12) Patent Application Publication
(10) Pub. No.: US 2019/0073900 A1
(43) Pub. Date: Mar. 7, 2019

(54) Integrally Lit Color Signal Flags For Motor Racing

(71) Applicant: Raymond J. Colbert, Pittsburgh, PA (US)

(72) Inventor: Raymond J. Colbert, Pittsburgh, PA (US)

(21) Appl. No.: 16/122,817

(22) Filed: Sep. 5, 2018

Related U.S. Application Data
(60) Provisional application No. 62/554,451, filed on Sep. 5, 2017.

(51) Int. Cl. G08G 1/0955; F21V 33/00; G09F 17/00

(52) U.S. Cl. CPC G08G 1/0955; F21V 33/008; F21Y 2115/10; G09F 2017/0083; G09F 2017/0033; G09F 17/00

(57) ABSTRACT

Signal flags for use in motor racing which are shown or waved by section signalers/observers on racing courses and respectively consist of a colored flag cloth as well as a flag rod provided with a handle. On the flag cloth is at least one light emitting element is provided, preferably in the form of an electric blinking lamp which emits light with a high intensity in the same color as the flag cloth.

### CROSS-REFERENCE TO RELATED APPLICATION

This is a perfection of U.S. Provisional Application Ser. No. 62/554,451, filed on Sep. 5, 2018, the disclosure of which is fully incorporated by reference herein.

### BACKGROUND OF THE INVENTION

### 1. Field of Invention

This invention relates to signal flags for improved motor racing visibility/safety, particularly for use by section observers on various racing courses.

### 2. Discussion of Related Art

There are numerous known devices for uplighting, or downlighting a display flag such as a country flag from the pole suspending that flag. Representative examples include those shown and described in U.S. Pat. Nos. 4,833,443, 5,988,100, 6,192,824 and 8,746,928, Published U.S. Application Nos. 20060023446, 20070089338 and 20140301083, and PCT Application Nos. 2008031365 and 2016202348. Then there's the very use of lighted poles for improving the visibility of motor racing flags per U.S. Pat. No. 6,380,863.

It is also known to provide fabric/materials with internal lighting per U.S. Pat. No. 4,234,90; and illuminated team pennants/logos like those shown in U.S. Pat. Nos. 4,110,818 and 8,146,278. Lastly, Published U.S. Application No. 20080205898 showed adding fiber optics to the body of a flag. But, none of the foregoing, add color-coordinated LED lights to the body of a motor racing flag for improved visibility!

As is commonly known, the section observers prescribed by regulations in motor racing, like those of the Sports Car Club of America (or “SCCA”), have a duty to observe the section of racing course allocated to them and to transmit certain information and instructions to the drivers. For this purpose, each section observer has a predetermined number, at least six, signal flags in different colors. By waving one of these flags, a certain racing situation is indicated to the drivers, and a corresponding instruction or warning is given.

For racing drivers to better see and recognize the particular flag signal color being waved by the section observer, that flag must be displayed in the direct field of vision of the drivers. For reasons of safety, present day racing courses have widened lateral roll spaces and elastic barriers between the racetrack and the audience. Since the section observers also have to be positioned on the outside of these roll spaces, danger has increased that a section observer waving a selected signal flag may be overlooked or not noticed in time.

### SUMMARY OF THE INVENTION

It is a primary purpose of the invention to increase the visibility effect of the signals shown by the section observers and to increase the overall safety of motor races.

This purpose is met, at least in part, by providing light emitting diode (or “LED”) elements that don't get too hot and raise potential burning hazards, then adding such LED's in one or more given increased visibility patterns DIRECTLY into the body of the flag itself, i.e., its cloth component (either by after-market additions, or by incorporating such lights into the manufacture of NEW racing flag bodies). By this means, visibility of the signal flag being waved significantly increases, especially during unfavorable visual conditions like an extra cloudy day, slight fog or even the start of a misty rain (before the race is stopped for such weather-related delays.

Simple handling of these new, greater visibility flag bodies is advantageously realized by providing an energy supply for the light elements in the flag cloth, either adjacent an inconspicuous section of the flag body (i.e., its rear face or less visible corner), or from the very flag rod to which this new flag body extends. Alternately, light sourcing can be provided via rechargeable electric batteries connected to the respective light elements by means of an on/off switch on the flag body or flag rod adjacent its handle.

The blinking from cold-to-the-touch LED strips make this invention more practical than the flag POLE lighting system for motor racing known in the art and described above. Colored LED strips matching the color(s) of the flag bodies make them more likely to be seen by the drivers racing past these flags and, with preferred flashing/pulsing (or pulsating) patterns in such light strips, even greater likelihood of detection without distraction results. There are also numerous sections of continuously lit string or rope lights that can be included in the scope of this invention, for greater visibility.

### DESCRIPTION OF THE DRAWINGS

The objects, advantages and features of this invention will be more readily appreciated from following detailed description, when read in conjunction with the accompanying drawings in which:

FIG. 1 shows a front perspective view of a representative “green” flag from a top waiving pole or post per this invention used for signaling the start of a race, said flag having one set of lower LED lights, in green, running horizontally along the lower base and a second set of green LED lights running vertically, both sets of lights meeting in a lower right corner of the flag as shown. Though not shown, a corresponding “red” flag, with two or more perimeters containing a plurality of red LED lights, would be used to signal to all drivers to stop immediately where they are due to a track emergency;

FIG. 2 shows a front perspective view of a representative “yellow” flag from a top waiving pole or post per this invention used for signaling a caution to all drivers in the race, said flag having one continuous set of yellow “string” lights running about the entire perimeter of this yellow caution flag;

FIG. 3 shows a front perspective view of a representative white flag from a top waiving pole or post per this invention used for signaling “one lap remaining” to all drivers in the race, said flag having three sets of white LED lights running, in a U-shape about and along both sides as well as the bottom of this white flag;

FIG. 4 shows a front perspective view of a representative center circle (or “meatball”) flag per this invention used for signaling to one designated driver whose number would be shown in the middle of this flag, preferably lit along with the surrounding warning signal, to inform that driver that he/she may be experiencing mechanical problems and should return to the pit area of the racetrack as soon as possible;

FIG. 5 shows a front perspective view of a representative diagonally striped blue flag, the stripe being either orange (as shown) or alternatively yellow, with both the blue triangles and orange stripe being duly lit with string lighting according to this invention. This flag is meant to signal a specific driver that he or she should move to the outside so that a faster approaching driver may safely pass them on the track;

FIG. 6 shows a front perspective view of a black flag having a string of dark blue lights (for visibility, better than black-on-black) to signal all drivers to leave the track immediately (or as soon as possible) due to an emergency condition; and

FIG. 7 shows a front perspective view of the so-called checkered flag, integrally lit according to this invention with white LED lights in the center of the white squares and with dark blue lights in the centers of the adjoining, intermittent black squares (in the same vertical and/or horizontal row, for signaling to all drivers that this particular race on the track has ended.

### DESCRIPTION OF PREFERRED EMBODIMENTS

The Sports Car Club of America (or “SCCA”) has a group of several well-established signal flag colors. They include: “Yellow” for notifying drivers to slow down because something hazardous like an accident, or potentially hazardous is in the area and that passing is prohibited. There are also “Waving yellow” flag situations warning drivers that they may need to take evasive actions or stop to avoid an obstruction, and “Double yellow” flags for a full course/trackwide notification to all drivers.

“Green” is an indication of a clear or free track and that racing is underway; “Red” indicates a termination of the race and ALL drivers must stop on the side of the course; and “Blue” notifies a driver that another car is rapidly approaching and the slower driver should check his/her mirrors to let the oncoming driver to pass. More often, the solid blue flag is supplemented with a yellow or orange slash.

A “White” flag notifies drivers that one or more service vehicles, or a slower car with mechanical issues is on the course. A “Yellow-red” flag combination, striped or alternating somehow, indicates that there is a contamination on the race track, such as oil, gas, water, sand, gravel, mud, rocks, car parts or other debris.

A mechanical flag, often a black or other dark colored flag with a centrally-located orange circle, (hence the nickname “meatball”) tells a driver that he/she is experiencing mechanical problems/issues and that their car should return to the pits as soon as possible/practical. With the advancement of more flexible, curvy LED screen technologies, it is expected that a next-generation of this particular Black flag model will contain a large central screen that can be programmed to brightly display (a white number on a black background) a particular driver number programmed into that flag via a handheld remote control thus eliminating the need for signalers to hold both a Black flag AND a chalkboard driver number indicator at the same time.

There is also an open “Black” flag, accompanied by a number board display, for notifying a specific driver (via the number indicator) to return to the pits and meet with the race officials, perhaps due to an alleged observation of improper actions having been taken. When black flags are displayed at all corner stations, the race will be halted and all cars must return to the pits.

Finally, there is the “Checkered” (black AND white) flag for telling all drivers that a race/session/heat has ended.

The signal flag of this invention has the dimensions of conventional signal flags for section observers. It consists of a lightweight flag rod having a piece of white or colored flag fabric (or cloth) hanging therefrom, the color or colors of which are prescribed by the regulations described earlier herein.

On the body of that flag cloth would be mounted a multitude of blinking lamp strips, either straight or curved, LED's most preferably, for emitting high intensity light flashes in the same main color of the flag cloth itself (i.e., green lights for green, yellow for yellow, red for red, etc.). As compared to conventional unlit signal flags, the visibility effect from this invention would be increased several fold by the blinking/pulsing operations of the high intensity/low temperature lamps and by their high light performance.

For the current supply to the lamps built in or added to such flag bodies, powering batteries may be connected by a dot chain line to either the start of a given light string, or from the flag holding post/pole/handle. In any event, these light strings would include twofold operation means: a first handheld “on-off” remote control AND a separate (backup) on-off switch nearer the battery source or start of the lights themselves (for use in an emergency). When multiple colors of LED lights are embedded in the same cloth for reducing the overall number of flags needed: i.e. to consolidate common flags by having a red stripe addition to a yellow only flag body, for example, the handheld remote controls would need to have further “channel selections” for alternating between light modes to be turned on, as needed.

In yet another variation of the foregoing, a central area for a Black flag may have a set of LED lights about its perimeter. But in addition to those lights, the same central area may further include a flexible screen, black background display from which a bright driver/car number may be broadcast, that number being punched in/programmed from a larger handheld (with a numbered keyboard included).

Positioning of these lights about the flag body may take on several variations as well. At a minimum, a single string of LED's may extend horizontally from the lower flag edge opposite its connecting edge to the flag waving post/pole/handle.

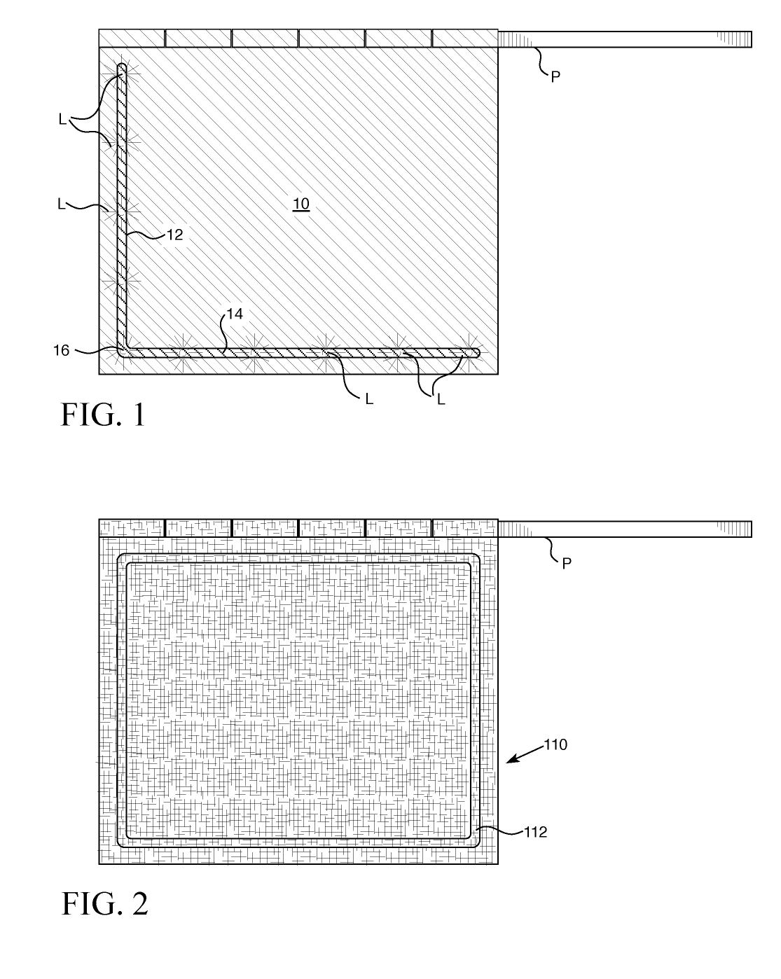

A second, more preferred variation would include a horizontal AND vertical light strip combination, even more preferably meeting at one of the lower corners to this flag body (as best seen in FIG. 1). Yet another option would include LED lighting from 3 perimeter/sides to this flag body, both sides and the bottommost edge. Or a fourth line of lights (either LED or string lights) may be added thereto across the flag body top (nearest the connecting post/pole/handle). With the latter, complete perimeter arrangement, it is possible to create a strobe pulsing effect of multiple light clusters chasing one another so as to be more eye catching without being unduly distracting.

Of course, still other variations may add a lighted X-shape to the middle of this flag body (in a coordinating color), or a square or diamond. The possible addition of a lighted circle has to be lessened since the “Meatball” flag above already incorporates a circle into its preferred pattern shape thereon.

Referring now to the accompanying drawings, there is shown in FIG. 1 a green flag 10, hanging downward from its attachment (or waiving) pole P, each of these poles having a flag mounting end and a pole handle for a signal operator to use when picking up a given flag and waiving it about depending on the condition or event being experienced by the drivers racing about the course, or track.

For improved visibility for this “Start of the Race” signal—to all drivers, this invention equips the foregoing rectangular-shaped green flag 10 with at least one set of vertical perimeter lights 12 and another set of horizontally extending perimeter lights 14 that meet together at one corner 16. The respective lights (possibly LED, or of another high visibility alternative) illuminate along the trail of these two or more perimeters as indicated by the L designations therealong.

For the yellow caution flag at FIG. 2, item 110, there is included one continuous set of yellow-colored string light 112, preferably interwoven into the fabric making up this yellow, caution-signaling flag. It should be noted that while the first sets of flags include LED lights, or string lights in the alternative, either arrangement may be used with any of the flags of this invention, along any two or more perimeter edges so as to best improve flag visibility by the drivers racing by the signalers at high speeds on a given racetrack.

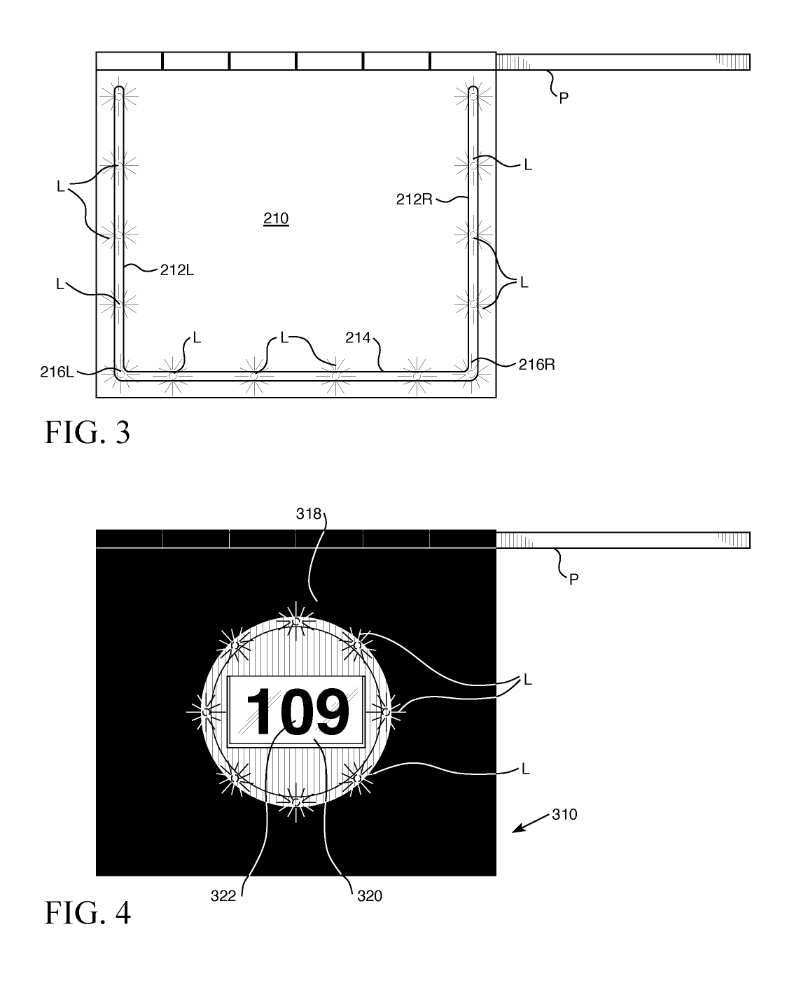

FIG. 3 shows a white racing flag 210 hanging down from its waiving pole P, this flag usually signaling “last lap” or one lap remaining, to the end of this particular race. As shown according to this invention, flag 210 includes a plurality of vertically-extending white LED light strips, 212L and 212R, with the respective bright lights L illuminating therefrom. At least one strip of horizontal white LED lights 214 runs along yet another perimeter edge of flag 210 with the strips of vertical and horizontal LED lights meeting (to form one continuous U-shape) at the respective corners 216L and 216R.

FIG. 4 shows a flag with a black (or dark) background 310 hanging down from its pole P. To best notify a particular driver that he/she is experiencing mechanical problems and needs to report back to the pit area, the center circle 318 of flag 310, in orange most often (hence the nickname, “meatball”) has a surround of orange LED lights (indicated by illumination letter L) with a centermost rectangle 320 having a numerical indicator 322 (for changing remotely) to specifically identify the racing number of the driver in question . . . in this representative case, the driver of car 109. It is far advanced over the present day usage of a separate Meatball flag with a handheld chalkboard on which the driver's no. is written—a two handed, or two signaler operation!

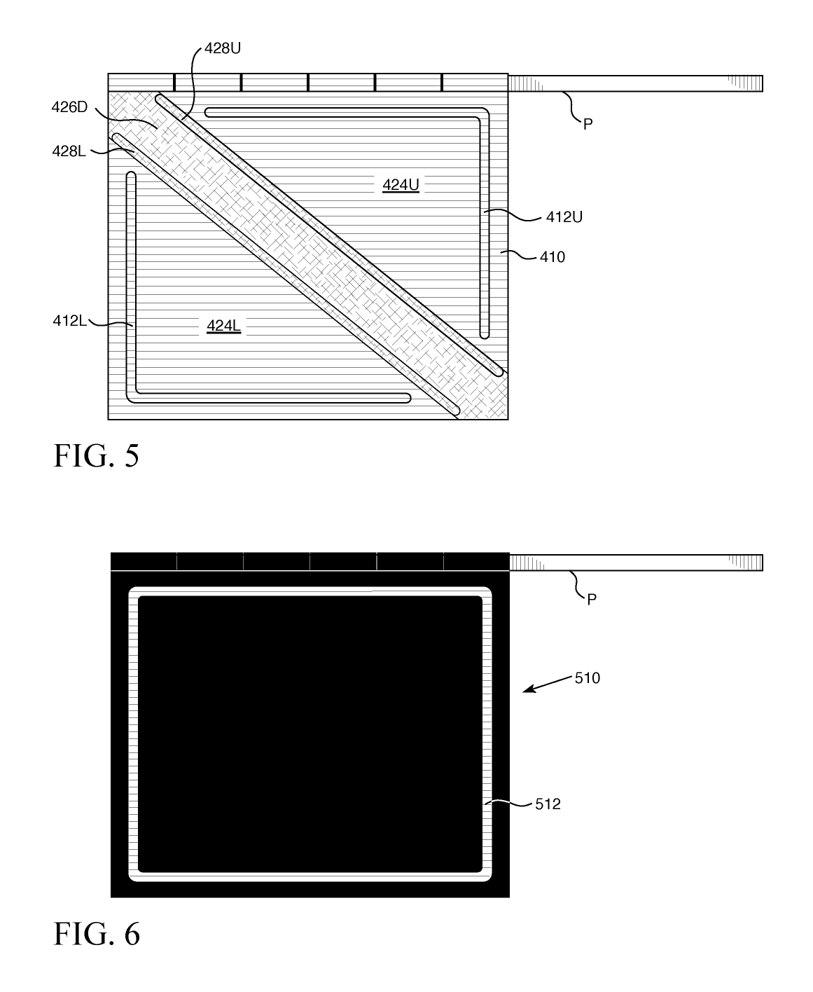

FIG. 5 is a rectangular blue flag 410, from pole P, divided into an upper triangle region 424U and its corresponding lower rectangle 424L by a diagonally extending slash of orange 426D (or sometimes, yellow in the alternative). This flag is meant to inform a particular driver to whom it is waived that that driver should move to an outside lane of the track in order for a fast approaching driver to safely pass him or her. Per the present invention, this flag includes a plurality of striped blue light ropes, 412L and 412U, respectively, with the centermost slash of orange (426D) also containing its own strip of orange (or yellow, in the alternative) identifiers . . . in this case a pair of spaced orange light stripes 428L and 428U.

FIG. 6 is a representative black flag 510 hanging down from its waiving pole P. This signals that all drivers must exit the track (as soon as practical/possible) due to an emergency. As shown, the black flag of FIG. 6 has one continuous string 512 of dark blue lighting about its whole perimeter. It is believed that such a dark blue-based light would provide greater visibility to the drivers than one having a solid black-on-black background alternative.

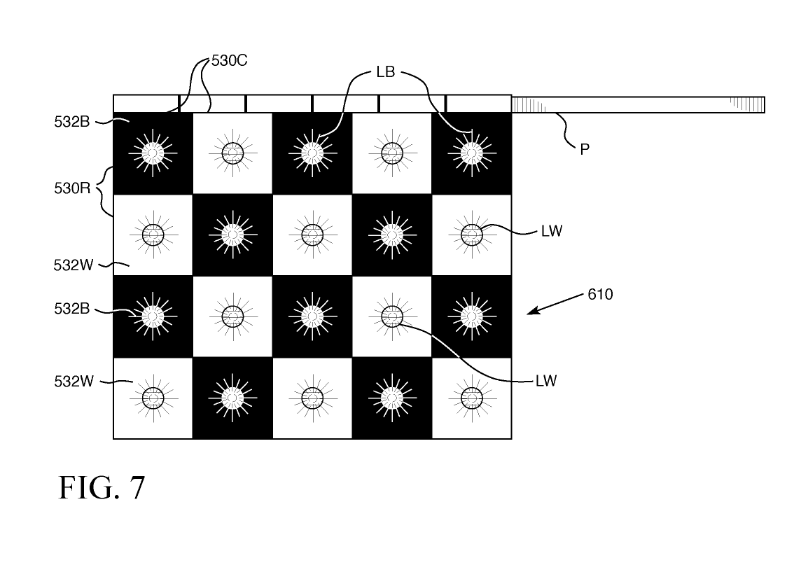

FIG. 7 shows the proverbial checkered flag 610, from its pole P. This flag that is meant to signal the end of a race (or heat, etc.) typically consists of alternating rows 530R of black and white squares adjacent alternating columns 530C for making a checkerboard-like pattern. At a minimum, the white squares to this flag 610 may have a single white LED light LW from the middle of each respective square. More preferably, the black squares can also be duly lit with a central dark blue light LB.

The electronic control units for any one or more of these lighted signal flags can use current LED lighting or strip light illumination means, with a typical on-off switch that runs to the pole handle. Alternatively, operation of these flags, especially the meatball version of FIG. 4, can be remotely handled for turning on all about a track from a common operating point. Furthermore, any one or more of these lighted flag upgrades can be turned on to run continuously, until turned off, or to strobe for even greater potential visibility.

Racing organizers and potential customers for this invention include, but are not limited to: the FIA (a worldwide racing sanctioner), NASCAR, IndyCar racing and NASA.

Having described the presently preferred embodiments, it is to be understood that the scope of this invention may be otherwise covered by the appended claims.

What is claimed is:

1. A signaling system for improved visibility, day or night, by motor racing drivers on a racing course, said system comprising:
(a) a plurality of colored signal flags, each signal flag corresponding to a particular condition or event on the racing course, each signal flag comprising:
(i) a rectangular flag body component in a color selected from the group consisting of: green, white, yellow, red, blue, black and checkered (i.e., black and white); and
(ii) a plurality of lights incorporated into the flag body, said plurality of lights corresponding directly with the color of the flag body, e.g. green lights in a green flag, said lights being powered from a source that can be turned on and off by a signal operator for the particular condition or event on the racing course; and
(b) a plurality of poles, each pole having:
(i) a flag mounting end onto which one of the colored signal flags is mounted; and
(ii) a pole handle end from which the signal operator may waive the flag associated with the particular condition or event on the racing course.

2. The signaling system of claim 1 wherein at least some of the flag bodies have at least one horizontally extending strip of colored lights along a bottom of the flag body.

3. The signaling system of claim 1 wherein at least some of the flag bodies have one or more vertically extending strip of colored lights along one lateral edge of the flag body.

4. The signaling system of claim 1 wherein at least some of the flag bodies have a plurality of horizontally extending strips of colored lights, and a plurality of vertically extending strips of lights in the same color as the horizontally extending strip of lights so as to form an outer perimeter of colored lights for the flag body.

5. The signaling system of claim 1 wherein at least one flag body has a centrally located, lighted circle.

6. The signaling system of claim 5 wherein the lighted circle includes a region from which a controller may add a driver's racing car number for temporary display.

7. The signaling system of claim 6 wherein the controller adding the racing car number is the signal operator prior to waiving the flag body to inform the driver of the racing car number being displayed that a mechanical condition has arisen.

8. The signaling system of claim 6 wherein the controller adding the racing car number is a track coordinator who remotely sends the racing car number to display on the flag bodies of one or more signal operators.

9. The signaling system of claim 1 wherein at least one black flag body has a centrally located LED screen onto which from one to three digit numbers can be remotely projected.

10. The signaling system of claim 1 wherein at least one flag body has a diagonal dash, extending from one upper corner to an opposite lower corner, said diagonal dash being colored yellow or orange and having at least one diagonally extending string of lights matching the color of the diagonal dash, i.e., either yellow or orange.

11. The signaling system of claim 1 wherein the plurality of lights incorporated into the flag body illuminate continuously when turned on.

12. The signaling system of claim 1 wherein the plurality of lights incorporated into the flag body illuminate in a pulse or strobe when turned on.

13. An improved signal flag for motor racing about a race track, said signal flag providing greater daytime visibility to drivers racing about the race track, said signal flag comprising:
at least one rectangular flag body for mounting onto a flag pole, said flag body being in a color selected from the group consisting of: green, white, yellow, red, blue, black and checkered (i.e., alternating black and white);
at least one light emitting element for incorporating into the flag body, said light emitting element matching the at least one flag body in color;
an energy supply; and
a remote control for at least temporarily illuminating said at least one light emitting element in the flag body.

14. The signal flag of claim 13 wherein the light emitting element includes at least one horizontally extending light strip along a bottom edge of the flag body and at least one vertically extending light strip along one lateral side of the flag body.

15. The signal flag of claim 14 wherein the at least one horizontally extending light strip and the at least one vertically extending light strip include a plurality of LED lights.

16. The signal flag of claim 13 wherein at least one of the flag bodies has a plurality of diagonally extending light strips.

17. The signal flag of claim 13 wherein at least one of the flag bodies has a centrally located, lighted circle into which a driver's racing car number can be inputted and temporarily digitally displayed.

18. The signal flag of claim 13 wherein the light emitting element incorporated into the flag body illuminates continuously when turned on.

19. The signal flag of claim 13 wherein the light emitting element incorporated into the flag body illuminates in a pulse or strobe when turned on.
